(19) United States
(12) Patent Application Publication
(10) Pub. No.: US 2017/0049062 A1
(43) Pub. Date: Feb. 23, 2017

(54) SYSTEMS, METHODS, AND APPARATUSES FOR ROOT DEVELOPMENT

(71) Applicants: Lawrence Van Such, Powell, OH (US); Kelvin Bester, Pretoria (ZA)

(72) Inventors: Lawrence Van Such, Powell, OH (US); Kelvin Bester, Pretoria (ZA)

(21) Appl. No.: 15/241,999

(22) Filed: Aug. 19, 2016

Related U.S. Application Data
(63) Continuation of application No. 62/207,363, filed on Aug. 19, 2015.

(51) Int. Cl. A01G 29/00; B05B 3/02; A01G 1/00; B05B 1/02; A01G 25/06; A01G 25/16

(52) U.S. Cl. CPC A01G 29/00; A01G 25/06; A01G 25/167; A01G 1/001; B05B 1/02; B05B 3/02

(57) ABSTRACT

Systems, methods, and apparatuses for root development are provided. In one embodiment, an apparatus for developing a root system on a vascular plant and influencing a direction and concentration of root growth is provided, the apparatus comprising: a dome operable to support and encourage a direction and concentration of root growth, the dome comprising: an outer surface, an inner surface, and an internal volume, wherein the outer surface is configured to contact and support the root system to train the direction and the concentration of the root growth on the root system, and wherein the inner surface limits the internal volume of the dome; and a liquid distribution device, the liquid distribution device operable to distribute a liquid within the internal volume of the dome.

### CROSS-REFERENCE TO RELATED APPLICATIONS

This application claims priority from U.S. Provisional Patent Application No. 62/207,363, filed on Aug. 19, 2015, which is incorporated by reference herein in its entirety.

### BACKGROUND

Vascular plant systems (i.e. tracheophytes) have specialized tissue systems to move water and nutrients throughout the plant, while also having specialized tissue systems to conduct photosynthesis. Vascular plants include common plant groups such as: ferns, gymnosperms (e.g., conifers), and angiosperms (e.g., flowering plants).

On account of specialized vascular tissue to distribute water, nutrients, and other resources throughout the plant, vascular plants have evolved to much larger sizes than non-vascular plants. Common names for vascular tissues on vascular plants (hereinafter, “plants”) include “stems” and “roots.”

Roots typically lie beneath the surface of the soil, but may be aerial, and aerating (i.e. growing above ground). Roots are not only important for support of the plant, but are also important for uptake of water, nutrients, and other resources from the soil or other rooting environment to provide and transport these resources to tissue systems in other areas of the plant. Maintaining a healthy root system may provide additional benefits to tissue systems in other areas of the plant.

The present application is directed to novel systems and methods used for root development in a plant.

### SUMMARY

In one embodiment, an apparatus for developing a root system on a vascular plant and influencing a direction and a concentration of root growth is provided, the apparatus comprising: a dome operable to support the root system of the plant and encourage the direction and the concentration of root growth on the root system, the dome comprising: an outer surface, an inner surface, and an internal volume, wherein the outer surface is configured to contact and support the root system to train the direction and the concentration of the root growth on the root system, and wherein the inner surface limits the internal volume of the dome; and a liquid distribution device, the liquid distribution device operable to distribute a liquid within the internal volume of the dome.

In another embodiment, a system for developing a root system in a plant and influencing a direction and a concentration of root growth is provided, the system comprising: a container comprising a first internal volume; a dome operable to support the root system of the plant and encourage the direction and the concentration of root growth on the root system, the dome comprising: an outer surface, an inner surface, and a second internal volume, wherein the outer surface is configured to contact and support the root system to train the direction and the concentration of the root growth on the root system, and wherein the inner surface limits the second internal volume of the dome; and a liquid distribution device, the liquid distribution device operable to distribute a liquid within the first internal volume and the second internal volume.

In another embodiment, a method for developing a root system in a plant is provided, the method comprising: providing a dome internal side down relative to a ground reference in a growing medium, the dome comprising a liquid distribution device within an internal volume; planting a plant, wherein the plant is at least one of: a seed, a sprout, a seedling, and a rooted plant, in the growing medium, the plant directly overlying the dome; spraying a liquid with the liquid distribution device within an internal volume of the dome to cause a condensation to form on an inner surface of the dome, wherein the condensation begins a flow of the liquid along the inner surface of the dome toward a growing environment at a location underneath the dome; and absorbing the liquid in the growing environment underneath the dome to cause a root system of the plant to grow in a direction of the dome and the growing environment underneath the dome, such that the root system of the plant contacts the dome as the root system grows toward the growing environment underneath the dome, wherein the dome influences a direction and concentration of growth in the root system.

### BRIEF DESCRIPTION OF THE DRAWINGS

The accompanying figures, which are incorporated in and constitute a part of the specification, illustrate various example systems, methods, and results, and are used merely to illustrate various example embodiments.

FIG. 1A illustrates an example root system in a plant.

FIG. 1B illustrates example root systems in plants.

FIG. 2 illustrates a perspective view of an example root development apparatus.

FIG. 3 illustrates a perspective view of an example root development apparatus.

FIG. 4 illustrates a perspective view of an example root development system.

FIG. 5 illustrates a schematic view of an example control system for an example root development system.

FIG. 6 is a flowchart showing an example method for using a root development apparatus and root development system.

FIG. 7 is a flowchart showing an example method for using a root development apparatus and root development system.

FIG. 8 is a flowchart showing an example method for using a root development apparatus and root development system.

### DETAILED DESCRIPTION

The embodiments disclosed and claimed herein depict and describe systems, methods, and apparatuses for root development.

A root system on a plant plays an important role in development of the plant. A plant's root system may: absorb water, other liquids, and inorganic nutrients from a surrounding growing medium; anchor the plant to the growing medium or ground, and thereby support the plant; store food and nutrients for later use by the plant; and may be used for vegetative reproduction (e.g. cloning). As used herein, a root system may refer to any above-ground aerial and aerating root systems, as well as any root systems within a growing a medium. Root systems within a growing medium may include root systems totally or partially covered, enveloped, or submerged within a growing medium, for example, a sub-surface root system covered in soil. Recognizing a root system may not be limited to one growing environment or growing medium, as used herein, “above-ground” plant systems may refer to plant systems other than a plant's root system, for example, stems, trunks, branches, leaves, flowers, fruits, and the like. “Ground,” “ground surface,” “earth surface,” and like terms may refer to a threshold between a growing environment of a plant's root system and a growing environment for a plant's above-ground systems. “Underground” may refer to a growing environment of a plant's root system. For example, “underground” may mean underneath a surface of the earth, subterranean, beneath a top layer of a growing medium (e.g., under a top layer of soil in a container), and the like.

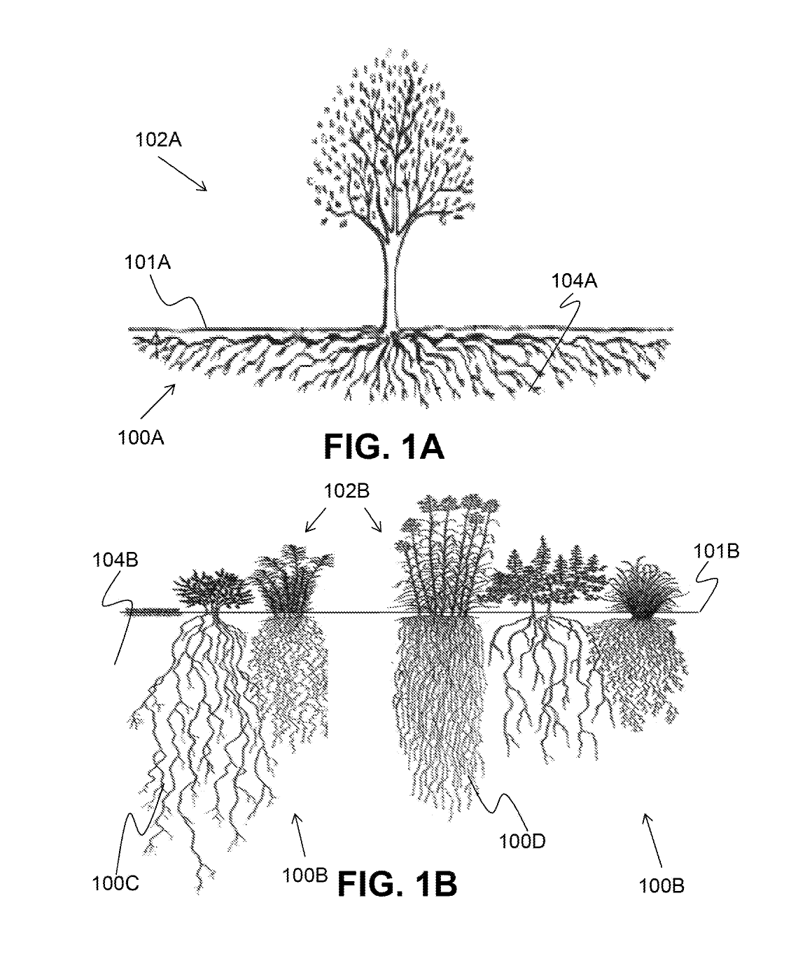

With reference to FIGS. 1A and 1B, example root systems for various plants are illustrated. Root systems may be unique to each plant species and unique to each plant itself. A size and shape of a root system may be influenced by many factors in a plant's growing environment.

With reference to FIG. 1A, an example root system 100A for a tree 102A is illustrated. Root system 100A may be relatively shallow—that is, root system 100A in underground growing environment 104A may be relatively close to ground surface 101A. Example root system 100A may be relatively wider, and more spread out than above-ground plant systems (e.g. trunk, branches, and leaves) of tree 102A.

With reference to FIG. 1B, example root systems 100B for prairie grasses 102B are illustrated. Root systems 100B may vary from species to species of prairie grasses 102B. Some root systems 100C may be spread out and sparse in comparison to some root systems 100D that may be more densely packed. Root systems 100B may vary in depth relative to each species. Underground growing environment 104B for a prairie may be relatively dry based on rainfall levels and soil drainage conditions common to a prairie biome. Some root systems 100B may grow to deeper levels in underground growing environment 104B in search of water and nutrients located deep within underground growing environment 104B, relative to ground surface 101B, to satisfy needs relative to each species of prairie grass 102B. Generally, root systems may grow in any direction toward an environment with resources to support a plant's needs. For example, roots may grow toward an area having water and nutrients to support a plant's needs. Root systems may not grow toward, or alternatively, may grow in a direction opposite of, environments lacking resources to sustain plant life. Generally, a well-developed root system may cause a better development of above-ground plant systems. Root systems generally may exhibit negative phototropism, and may generally grow in an environment of limited light source/stimulus, or may grow in a direction away from a light source/stimulus.

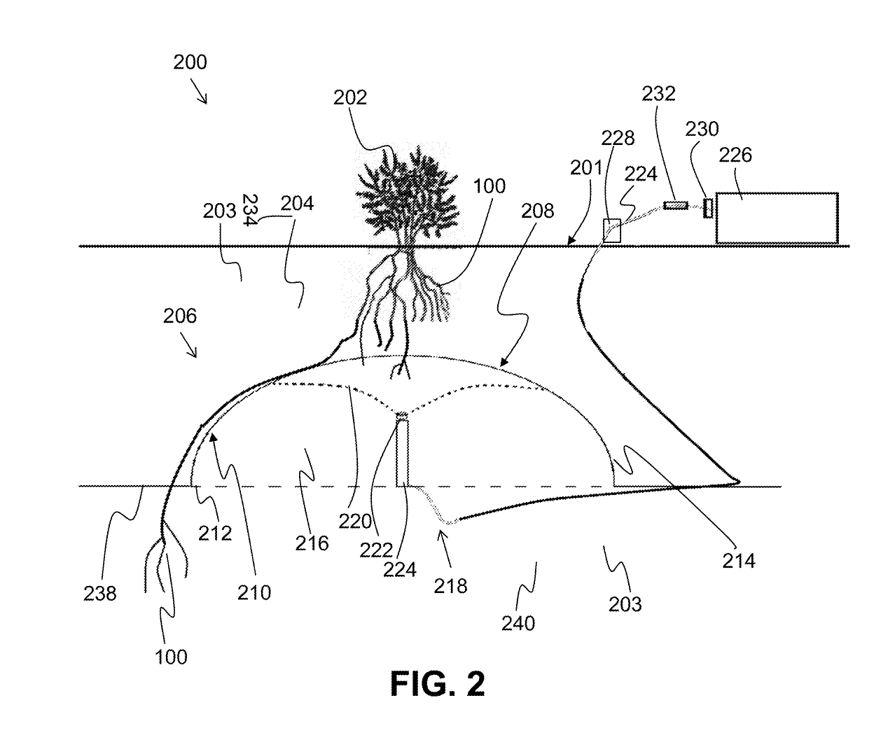

With reference to FIG. 2, an example apparatus 200 for root development is illustrated. Root development apparatus 200 may comprise dome 206 and liquid distribution device 218. Root development apparatus 200 may create an environment to support and develop root growth, which may cause better growth and development of all of a plant's systems and tissues as a whole. Root development apparatus 200 may influence a direction and concentration of root growth to provide a plant with an ideal root system for accelerated plant growth and development.

Dome 206 may comprise: a shell 214 comprising an outer surface 208 and an inner surface 210; and an internal volume 216. Dome 206 may comprise a shape selected from the group chosen from: a cone shape, a cylindrical shape, a pyramid shape, a frustoconical shape, a frustum shape, and an incomplete ellipsoid shape. An incomplete ellipsoid shape may be any of an ellipsoid, a spheroid, and a sphere comprising less than all portions of a complete ellipsoid, spheroid, and sphere. For example, an incomplete ellipsoid shape may include such shapes as hemispheres and half-spheroids. In one embodiment, dome 206 may be hemispherical in shape. Dome 206 may be comprised of a solid material that may resist deformation or breakage from forces that may be applied to dome 206. In one embodiment, dome 206 may be of a material that may resist deformation and breakage from a weight of growing medium 203 acting on dome 206 when apparatus 200 may be used in an underground growing environment 204. In another embodiment, dome 206 may be of a material that may resist deformation and breakage from forces of root system 100. For example, dome 206 may be of a material that may resist deformation and breakage from a weight of root system 100. In another example, dome 206 may be of a material that may resist penetration by one or more root elements in root system 100. In another embodiment, dome 206 may be of a material that may resist deformation and breakage from above ground forces acting on ground surface 201 that may subsequently apply force on dome 206. For example, dome 206 may be of a material that may resist deformation and breakage from a weight of an above-ground object (e.g. person, vehicle, sidewalk, pet, equipment, etc.) acting on ground surface 201 near plant 202. Dome 206 may be of a solid material chosen from the group of: a plastic, a metal, a ceramic, a glass, a natural fiber, a synthetic, and a composite. In one embodiment, dome 206 may be of an acrylic material. In another embodiment, dome 206 may be of a metal material, such as, for example, a non-reactive metal resistant to oxidation, such as stainless steel. Material of dome 206 may be selected based on conditions of the underground growing environment. Material of dome 206 may be selected based on design and manufacturing requirements of dome 206. For example, dome 206 may use a thermoplastic polymeric material suitable for injection molding to mass manufacture dome 206 in a certain shape based on an injection mold. In one embodiment, material of dome 206 may be of a decomposable, dissolvable, or compostable material that may over time break down into simpler materials and be integrated into underground growing environment 204 and growing medium 203. For example, dome 206 may be of an organic material that may decompose and be recycled as a fertilizer, amendment, or other additive in growing medium 203. Dome 206 may vary in size to accommodate root system 100 of plants of varying size. For example, dome 206 may be relatively small in size to accommodate root growth and development of a seedling, and a larger size dome 206 may be required when a seedling is transplanted into a different underground growing environment 204.

Outer surface 208 of dome 206 may be oriented in a direction toward ground surface 201, as illustrated in FIG. 2. Outer surface 208 may be used to at least one of: support root system 100; direct and encourage a direction and concentration of root growth of root system 100; and separate and distribute root system 100. While FIG. 2 is illustrated as a two dimensional view for clarity, it is understood that root system 100 may contact outer surface 208 of three dimensional dome 206 in all directions. In one embodiment, outer surface 208 may uniformly distribute root system 100 in all directions.

In one embodiment, outer surface 208 may comprise a coating selected from the group chosen from: a rooting hormone, a mycorrhizae, a beneficial fungi, a beneficial bacteria, a nutrient, a herbicide, a pesticide, and a fertilizer. For example, outer surface 208 may comprise a rooting hormone containing classes of plant hormones such as auxins, cytokinins, and like signal molecules, to regulate cellular processes in root system 100 such as root growth, root enlargement, root expansion, root development, and the like, such that contact with a rooting hormone by root elements may cause a cellular process response in root system 100. In another embodiment, outer surface 208 may comprise at least one of: a beneficial fungus (i.e. mycorrhiza), and a beneficial bacteria such that contact by root system 100 may cause or encourage a symbiotic, mutualistic relationship to occur between root system 100 and respective beneficial fungus and beneficial bacteria. In another embodiment, a nutrient and fertilizer coating may be used to provide root system 100 with necessary nutrients. In another embodiment, a herbicide/pesticide coating may inhibit, limit, and discourage growth of, for example, roots from other plant systems competing with root system 100 for resources, nematodes, oxysporum, and the like. Likewise, inner surface 210 of dome 206 may comprise a like coating.

Dome 206 may comprise inner surface 210. Inner surface 210 may be distinguished from outer surface 208 relative to threshold rim 212. Dome 206 may be hollow such that inner surface 210 and outer surface 208 may comprise shell 214 of dome 206, such that inner surface 210 may define and limit an internal volume of void/cavity (“internal volume”) 216 within shell 214. Shell 214 may limit an ingress of, for example, root system 100 and growing medium 203 into internal volume 216, while also selectively limiting and directing an egress of liquid from internal volume 216 to areas external to internal volume 216.

Root development apparatus 200 may further comprise a liquid distribution device 218. Portions of liquid distribution device 218 may be located and structured within internal volume 216. In one embodiment, a liquid output 220 from liquid distribution device 218 may be selectively and temporarily retained within internal volume 216. In another embodiment, a liquid output 220 from liquid distribution device 218 may be selectively and temporarily retained within internal volume 216. For example, a liquid output 220 may be output within internal volume 216 as an atomized mist with small liquid droplets suspended in an air within internal volume 216. A temperature differential between a temperature of internal volume 216 and underground growing environment 204 in contact with dome 206 may cause atomized mist liquid output 220 to condensate on inner surface 210 of dome 206. Liquid output 220 on inner surface 210 of dome 206 may accumulate and bead into larger droplets on inner surface 210 of dome 206. Once larger droplets of beaded liquid output 220 form on inner surface 210 of dome 206, gravity may cause larger droplets of beaded liquid output 220 to flow along inner surface 210 of dome 206 toward rim 212. At rim 212, larger droplets of beaded liquid output 220 may drip from inner surface 210 and onto dome/growing interface 238, and further into deeper underground growing environment 240. In one embodiment, inner surface 210 may be coated with a surfactant to assist liquid output 220 into forming condensation and beaded droplets on inner surface 210 of dome 206, and rolling along inner surface 210 once droplets of liquid output 220 reach a certain size. As described above, inner surface 210 may comprise a coating, for example, a fertilizer. For example, liquid output 220 contacting inner surface 210 with a fertilizer coating may form a liquid fertilizer solution liquid output 220 that drip from inner surface 210 and onto dome/growing interface 238, and further into deeper underground growing environment 240, providing a fertilized solution to growing medium 203 in areas around dome/growing interface 238 and deeper underground growing environment 240.

Liquid distribution device 218 may output a liquid 220 within internal volume 216. Liquid distribution device 218 may further comprise a sprayer 222, and one or more tubes 224 to operatively connect liquid distribution device 218 to a liquid source 226. Sprayer 222 may affect how liquid output 220 may be output. For example, sprayer 222 may output liquid output 220 as an atomized mist of liquid vapor. In one embodiment, liquid distribution device 218 may be configured to output a liquid such as water. In another embodiment, liquid distribution device 218 may be configured to output a nutrient-rich liquid such as a liquid fertilizer. In another embodiment, liquid distribution device 218 may be configured to output a herbicide, and a pesticide. Components such as sprayer 222 and tubes 224 of liquid distribution device 218 may be selectively disconnected from liquid distribution device 218 as a whole, for example, to clean components of fertilizer salt accumulations to prevent clogs, and to replace components. In one embodiment, liquid distribution device 218 may accept modular components such that sprayer 222 and tubes 224 may modular, and may be selected based on a user's desired configuration of liquid distribution device 218 for use in root development apparatus 200.

Sprayer 222 may be used to output an atomized mist of liquid output 220. Sprayer 222 may comprise an output nozzle to atomize a liquid within tube 224 to provide liquid output 220 as an atomized mist. In one embodiment, sprayer 222 may be a mister nozzle attached to an end of tube 224. In another embodiment, sprayer 220 may be a mister nozzle with a 360° output to output an atomized mist of liquid output 220 in a 360° spray pattern. In another embodiment, sprayer 222 may be a spinner nozzle that may rotate from 0° up to and beyond 360° to output an atomized mist of liquid output 220 in a 360° spray pattern. For example, sprayer 222 with a spinner nozzle may use pressure of a liquid within tube 224, or a pressure of liquid output 220 as liquid output 220 may be output by sprayer 222 to mechanically spin and rotate sprayer 222 up to, and beyond 360° to provide a 360° spray pattern output. In another embodiment, tube 224 may rotate from 0° up to, and beyond 360° such that liquid output 220 from sprayer 222 may be output as a 360° spray pattern. Sprayer 222 may be operatively connected to tube 224, such that sprayer 222 may be removed from tube 224. In one embodiment, sprayer 222 may be removed from tube 224 to be cleaned so as to clean and remove any blockage from an output nozzle on sprayer 222.

Tube 224 of liquid distribution device 218 may be used to convey a liquid from a liquid source 226 to be output from sprayer 222. Tube 224 may be at least one of: a hard tube 224, and a soft tube 224, and any combination thereof. In one embodiment, tube 224, may be a hard tube such as a pipe. In another embodiment, tube 224 may be a soft tube such as a hose. Tube 224 may be of a material to withstand prolonged exposure to being buried in an underground growing environment 204. In one embodiment, tube 224 may be of a material to resist wear and erosion from both chemicals present in, for example, underground growing environment 204, and chemicals in a liquid within tube 224 itself. In another embodiment, tube 224 may be of a material that may resist prolonged exposure to full or partial submersion, for example, in a hydroponic growing environment. For example, tube 224 may be of a material resistant to drying out, or cracking, when removed from full or partial submersion in a hydroponic growing environment. Tube 224 may be of a non-reactive material that may resist reactions (i.e. corrosion) from at least one of: chemicals in an underground growing environment 204, and chemicals in a liquid within tube 224. Tube 224 may comprise a material or coating that may for example, resist or inhibit growth of mold, bacteria, and algae. Tube 224 may be, as a non-limiting example, of at least one of: a polymeric material, a plastic material, a rubber material, a non-reactive metal material, a glass material, a ceramic material, and the like. Tube 224 may be modular to allow tube 224 to be removed from liquid distribution device 218 to be exchanged for one or more tubes 224 of different configurations and materials, and to allow for cleaning of tube 224, for example, to remove a blockage or build-up from within tube 224.

Liquid distribution device 218 may be both operatively and selectively connected to a pressurized liquid source 226 to provide a pressurized liquid within tube 224 to be output at liquid output 220 by sprayer 222. For example, pressurized liquid within tube 224 may be of a higher pressure than that which may be achieved in a gravity fed liquid distribution device. In one embodiment, tube 224 of liquid distribution device 218 may be connected to a liquid source 226 such as a tap or a spigot connected to a municipal water supply to supply an operating pressure necessary for outputting liquid output 220 as an atomized mist. In another embodiment, tube 224 of liquid distribution device 218 may be connected to a liquid source 226 such as a tap or spigot of a well, whereby liquid from the well is pumped under pressure to a tap or spigot from the well via a pump (not shown). In another embodiment, tube 224 of liquid distribution device 218 may be connected to liquid source 226 via an auxiliary pump 228 to provide liquid within tube 224 with a necessary pressure to be output liquid output 220 as an atomized mist by sprayer 222. A liquid may not be ever-present within tube 224, and liquid flow within tube 224 may be actuated by a user (e.g. a user turning a tap or spigot to commence liquid flow within tube 224), or by a control device 230 such a solenoid valve operable to open and close to provide a pressurized flow of liquid within tube 224. In one embodiment, liquid source 226 may be a reservoir of liquid pumped and pressurized by pump 228 into tube 224 to supply liquid distribution device 218 with a pressurized liquid. Liquid distribution device 218 may further comprise an inline injector 232 for adding at least one of: a solid, a liquid, or a gas, to a liquid under pressure within tube 224. For example, inline injector 232 may be used to add solid and liquid fertilizer to a pressurized water from a municipal water supply within tube 224. Liquid distribution device 218 may further comprise one or more backflow preventers and check valves (not shown) to control a direction of fluid flow within tube 224 and prevent liquid within tube 224 from flowing in any undesired direction.

In one embodiment, dome 206 may be used to direct and distribute growth of root system 100 without use of liquid distribution device 218. An alternative liquid distribution device, for example a drip irrigation liquid distribution device 219 may be used to deliver a liquid source to a deeper underground growing environment 240. In this embodiment, root system 100 may use dome 206 to spread, direct, and space roots of root system 100, as roots grow toward deeper underground growing environment 240. In one embodiment, a dome/growing environment interface 238 may provide an approximate threshold between underground growing environment 204 and deeper underground growing environment 240. Deeper underground growing environment 240 may be called a “feed zone” to reflect a location where liquid output 220 is absorbed by growing medium 203. Feed zone 240 may be an ideal location to provide resources necessary for growth of plant 102 that may encouraging development of deep-growth roots on root system 100.

Dome 206 may further comprise a membrane 234 (illustrated as a dashed line in FIG. 2). Membrane 234 may be selectively permeable to allow for selective ingress/egress of items into internal volume 216 at dome/growing environment interface 238. For example, membrane 234 may be a screened membrane to prevent a growing medium, for example soil, at dome/growing environment interface 238 from entering into internal volume 216 when root development apparatus 200 is buried in an underground environment 204, but may allow for liquid output 220 to pass through membrane 234, and further into dome/growing environment interface 238. Membrane 234 may further prevent root system 100 from entering into internal volume 216 of dome 206. In one embodiment, root system 100 may be discouraged from entry into internal volume 216 of dome 206 due to a lack of constant moisture within internal volume 216. In another embodiment, membrane 234 may prevent an animal from entering internal volume 216. Base 236 of liquid distribution device 218 may act similar to membrane 234 in preventing unwanted items, objects, and organisms from entering into internal volume 216.

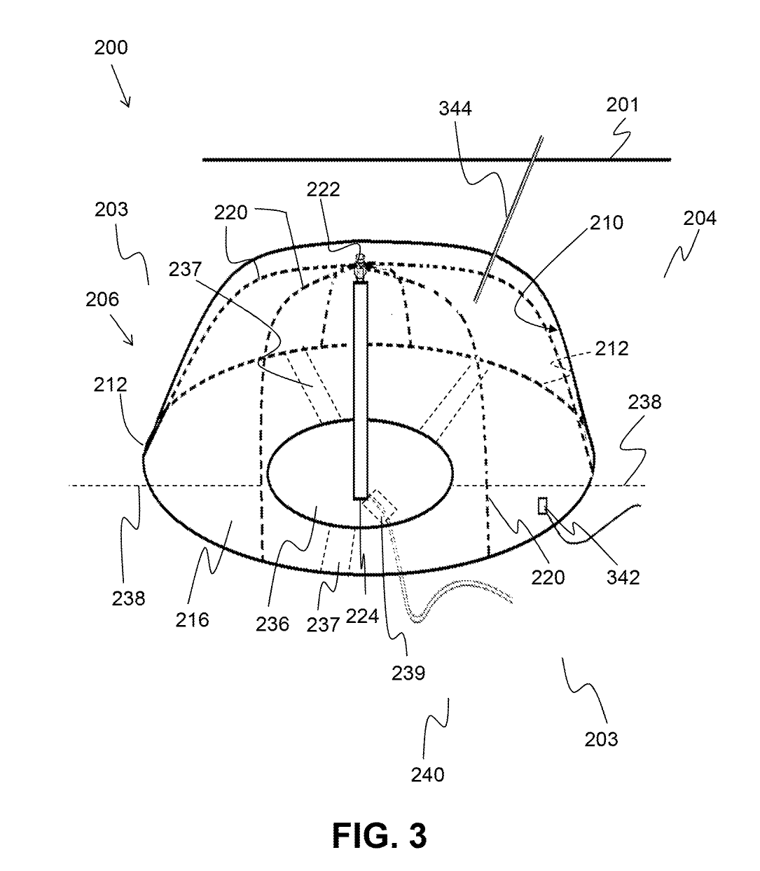

Referring now to FIG. 3, a perspective view of example root development apparatus 200 is illustrated. Example root development apparatus 200 may comprise base 236. One side of base 236 may rest on a threshold of dome/growing environment interface 238. For example, one side of base 236 may rest on growing medium 203 around dome/growing environment interface 238 with rim 212 of dome 206 also resting level with base 236 on growing medium 203 of dome/growing environment interface 238, such that base 236 may be used to prevent an ingress of growing medium 203 into internal volume 216. Base 236 may be used to operatively support and position liquid distribution device 218. For example, base 236 may connect to tube 224 with sprayer 222 positioned at one end, so as to position sprayer 222 as close as possible to inner surface 210 on dome 206 to encourage condensation of liquid output 220, output from sprayer 222 as an atomized mist. Portions of tube 224 may include additional protection hardware 239 surrounding tube 224 to protect and limit effects of subsidence of root development system 200, and shifting/settling growing medium 203, on tube 224. For example, settling growing medium 203 may cause a subsidence of root development system 200 which may affect an operation of tube 224. In this example, protection hardware 239 may at least one of: prevent, and limit, tube 224 from becoming at least one of: pinched, crushed, kinked, and tangled, due to a shifting/settling growing medium 203, and subsidence of root development system 200. In this example, protection hardware 239 allows tube 224 to convey a liquid within tube 224 to allow for normal and unhindered output of liquid output 220 from sprayer 222. In one embodiment, protection hardware 239 may be used to provide protection to a tube 224 comprising a soft material, for example, a rubber hose. In another embodiment, protection hardware 239 may be used to protect an interface of tube 224 comprising two different materials, for example, where a soft, flexible material hose 224 meets a rigid pipe 224. In one embodiment, base 236 may interconnect with dome 206 at rim 212 by one or more connecting members 237. In another embodiment, root development system may comprise base 236 without connecting members 237. Connecting members may be selectively removable from both of base 236 and rim 212, for example, by a connection hardware (not shown) that may include, but is not limited to: a tab and slot connection, a snap connection, a hook and loop fastener connection, a selectively removable adhesive connection, a ridge/recess connection, and like mechanical fasteners. At least one of: base 236, and connecting members 237, may be used to at least one of: prevent, and limit, a subsidence of root development system 200 on account of a settling growing medium 203, or an unstable growing medium 203. Connecting member 237 may be selectively expandable to vary a length of connecting member 237. For example, connecting member 237 may connect to base 236 and rim 212, and may further expand some distance past rim 212, and external to internal volume 216, to increase a footprint area of root development apparatus 200 within growing medium 203 to at least one of: prevent a subsidence of root development apparatus 200 within growing medium 203, and limit a subsidence of root development apparatus 200 within growing medium 203. In another embodiment, base 236 may be sized relatively similar (not shown) to the circumference/area created by rim 212 to act as a “lid” to prevent an ingress of material, for example soil, into internal volume 216. In this embodiment, base 236 may connect at one or more places on rim 212 via a hardware connection (not shown) on both base 236 and rim 212 to connect base 236 to rim 212. For example, base 236 may comprise a ridge/indentation, and rim 212 may comprise a corresponding ridge/indentation, such that ridge of base 236 may connect with corresponding indentation on rim 212, or indentation on base 236 may connect with corresponding ridge on rim 212—similar to common lid/container connection hardware. Base 236 may be of a semipermeable material to allow for selective ingress/egress of some materials into, and out of, internal volume 216. In one embodiment, base 236 may be of a material that may prevent or limit a growing medium 203, such as soil, from entering into internal volume 216, while allowing a liquid output 220 flowing on inner surface 210 of dome 206 to exit internal volume 216 around dome/growing environment interface 238. In another embodiment, base 236 may be a solid, impermeable material that may not completely connect to dome 206 via rim 212 to allow a liquid output 220 flowing on inner surface 210 of dome 206 to exit internal volume 216 around dome/growing environment interface 238. In this embodiment, an area/circumference of base 236 may be sized slightly smaller than an area/circumference of rim 212 to allow for a liquid output 220 flowing on inner surface of dome 206 to exit internal volume 216 around dome/growing environment interface 238. Base 236 and connecting member 237 may be of a rigid material to help limit and prevent a subsidence of root development apparatus 200 relative to growing medium 203. In one embodiment, at least one of base 236 and connecting members 237 may be connected to rim 212 at only select locations to provide for adequate egress of liquid output 220 flowing on inner surface 210 of dome 206. For example, at least one of base 236 and connecting members 237 may be connected only at selective intervals along rim 212, for example, at intervals of 0°, 90°, 180°, 270°, or intervals of 0°, 120°, 240°, intervals of or 0° and 180°, or like intervals, to allow for adequate egress of liquid 220 out of internal volume 216 and into dome/growing environment interface 238. Base 236 may further comprise rotational hardware (not shown) to rotate tube 224 from 0° up to, and beyond 360° to provide for a 360° spray output pattern of liquid output 220 as an atomized mist. In one embodiment, base 236 may rotate relative to stationary connecting members 237.

Dome 206 may comprise a heat exchanging element 342 and conduit 344. In one embodiment, conduit 344 may be used as heat exchanging element 342. In another embodiment, heat exchanging element 342 may be a separate, and unique device from conduit 344. Heat exchanging element 342 may be used to selectively heat and cool objects in underground growing environment 204 and deeper underground growing environment 240. In one embodiment, heat exchanging element 342 and conduit 344 may convey an above-ground air temperature to heat/cool a temperature of internal volume 216. In another embodiment, conduit 344 may comprise a copper pipe to conduct a heat of an air temperature in an above-ground environment, and absorb heat energy from the sun, to convey a heat to internal volume 216 so as to heat, and raise a temperature of air, vapor, and liquid in internal volume 216. In another embodiment, heat exchanging element 342 may be placed in-situ to heat/cool temperatures of objects in underground growing environment 204 and deeper underground growing environment 240. In another embodiment, heat exchanging element 342 may vary a temperature of internal volume 216 so as to vary condensation formation of liquid output 220 as condensation on inner surface 210 of dome 206. Conduit 344 may extend from internal volume 216, through dome 206 and above surface 201 and may be used to access internal volume 216 when dome 206 is buried in underground growing environment 204. Conduit 344 may be used to exchange air between internal volume 216 and air located at an above-ground location. Conduit 344 may comprise a cap or cover (not shown) to provide selective access to internal volume 216.

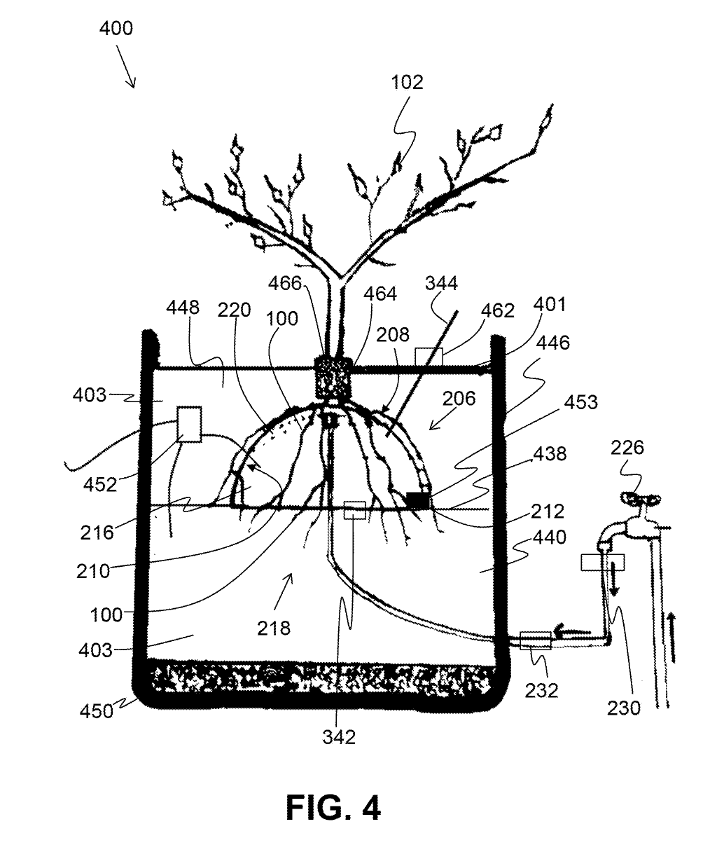

Referring now to FIG. 4, an example root development system 400 is illustrated. Example root development system 400 may incorporate elements of root development apparatus 200, and may provide a more controlled growing environment for plant 102 than growing with root development apparatus 200 alone. Root development system 400 may comprise container 446, and dome 206. Container 446 may comprise a first internal volume 448. Dome 206 may comprise: an outer surface 208 operable to support root system 100 of plant 102; an inner surface 210, and a second internal volume 216, wherein inner surface 210 of dome 206 define limits of internal volume 216. In one embodiment, container 446 may be used to contain a growing medium 403, such as soil, to form underground growing environment 404. Dome 206 may be buried within growing medium such that a plant 102 that may be planted near surface 401 of growing medium 403 may overlie dome 206. Root system 100 of plant 102 may grow toward dome 206, such that root system 100 may contact dome 206. Root system 100 may contact, be spread by, and grow around dome 206, such that root system 100 is spread out by dome 206 instead of forming a dense root ball during conventional plant growth without dome 206. Root system 100 may be spread by dome 206 and grow toward dome/growing interface 438 that may comprise growing medium 403 saturated by liquid output 220. Root system 100 may continue to grow past dome/growing interface 438 toward deeper underground growing environment 440 that may also comprise growing medium 403 saturated by liquid output 220. As root system 100 grows toward deeper underground growing environment 440, dome 206 may encourage root system 100 to spread-out, by encouraging root system 100 to grow around dome 206 to reach deeper underground growing environment 440. Necessary resources such as liquid output 220, may, due to gravity, flow from dome/growing interface 438 toward deeper underground growing environment 440 saturating growing medium 403 as liquid output 220 flows toward deeper underground growing environment 440. In turn, root system 100 may grow toward deeper underground growing environment 440 in search of resources, and may consequently develop deep roots such that root system 100 on plant 102 may become a deep-growth root system 100. A spread-out, and deep-growth root system 100 on plant 102 may encourage additional and accelerated growth of above-ground plant systems such as stems, leaves, branches, and the like.

Internal volume 448 of container 446 may better contain liquid output 220 than a natural underground growing environment 204. In one embodiment, container 446 of root development system 400 may comprise a drainage 450 to drain liquid output 220 from deeper underground growing environment 440. In one embodiment, liquid output 220 may be drained from internal volume 448 of container 446 to drainage 450. In another embodiment, liquid output 220 may be drained from drainage 450 external to container 446. For example, container 446 may include drainage holes (not shown) at or around drainage 450 to facilitate further removal of liquid output 220 from internal volume 448 of container 446 to drainage 450, and further through drainage holes so as to remove liquid output 220 from internal volume 448 of container 446. Plant 102 grown in natural underground growing environment 204 may have natural drainage that may drain liquid output 220 further to underground water tables, aquifers, and the like, or may drain liquid output 220 as runoff to drainage within a watershed system. Liquid output 220 drained externally from container 446 may be similarly drained to a natural underground growing environment 204, and further to an aquifer, or drainage within a watershed, or conversely recycled to be used as a liquid output 220 for future watering in root development system 400.

Root development system 400 may further comprise collar 464. Collar 464 may surround a main stem of plant 102 near surface 401 of growing medium 403. Collar 464 may limit a liquid accumulation on a main stem of plant 102 from flowing downward and accumulating in underground growing environment 404 where an excess accumulation of liquid may cause a malady of root system 100, such as root rot. Collar 464 may be filled with filler 466 to further control a flow of liquid through collar 464. Filler 466 may comprise a material that may partially absorb a liquid while providing adequate drainage through collar 464 so as to not cause any maladies to stem of plant 102 caused by poor drainage conditions. For example, filler 466 may be comprised of at least one of: silica sand, expanded clay pellets; perlite; vermiculite, mulch, coconut husk, and like materials.

Generally, all components of root development apparatus 200 and root development system 400 may be at least one of selectively: interconnectable, attachable, removable, and modular, to account for manufacturing, assembly, and logistic considerations. For example, root development apparatus 200 and root development system 400 may require assembly for proper operation prior to use. Components for root development apparatus 200 and root development system 400 may be stored in, for example, at least one of: internal volume 216 of dome 206, and internal volume 448 of container 446 to effectively package root development apparatus 200 and root development system 400 to save shipping space and shipping cost. Likewise, dome 206 may be interchangeable with another dome 206 of another root development system. In one embodiment, at least one of: dome 206, and container 446, may be able to nest in another of at least one of: dome 206, and container 446 to minimize storage space, for example, in a manufacturing facility, during manufacture of root development apparatus 200 and root development system 400.

Root development system 400 may comprise additional elements to better control an underground growing environment 404. For example root development system 400 may comprise control system 452 to fully or partially automate control of systems that may influence at least one of: underground growing environment 404, dome/growing environment interface 438, an environment of internal volume 216, and deeper underground growing environment 440.

A camera, 453 may be located within internal volume 216 of dome 206 and operatively connected to a display (not shown) to allow a grower to monitor internal volume 216 of dome 206. In one embodiment, camera 453 may comprise a light (not shown) to provide adequate illumination of internal volume 216 to observe internal volume 216 and surrounding areas. A light on camera 453 may be of a wavelength that may not affect photosensitive root system 100 on external surface 208 of dome 206, for example, a light in an infrared wavelength that may allow for low-light level viewing within internal volume 216. In one embodiment, dome 206 may comprise a material that selectively blocks light of certain wavelengths as to limit light exposure to root system 100 on external surface 208 of dome 206. Camera 453 may comprise a mount (not shown) comprising one or more motors (not shown) to provide camera 453 with rotational, pan, and tilt capabilities. In one embodiment, camera 453 may be operatively connected to, and controlled by, control system 452.

As described above, liquid output 220 output from sprayer 222 within internal volume 216 of dome 206 may form as condensation and droplets on inner surface 210 of dome 206. As condensation and droplets bead together to form larger drops, drops may flow along inner surface 210, past rim 212 and to dome/growing environment interface 438 where rim 212 may contact growing medium 403. Condensation may form when an interior temperature of internal volume 216 may be warmer than temperatures external to internal volume 216, for example a temperature of growing medium 403 surrounding outer surface 208 of dome 206.

Relative humidity may be a ratio between how much liquid vapor may be in an air, and a maximum amount of liquid vapor that may be held by an air. For example, relative humidity within internal volume 216 may measure an amount of vaporized liquid output 220 compared to a maximum amount of vaporized liquid output 220 that may be contained within internal volume 216. An increase in temperature may cause an air to retain more liquid vapor. For example, increasing a temperature of internal volume 216 may increase an amount of vaporized liquid output 220 an air within internal volume 216 may contain. In one embodiment, when a warm air within internal volume 216 saturated with vaporized liquid output 220 may come into contact with a colder inner surface 210 of dome 206, vaporized liquid output 220 may accumulate on inner surface 210 as a liquid vapor or as small liquid droplets.

Liquid output 220 may contact growing medium 403 as either a liquid droplet or a water vapor. In one embodiment, growing medium 403 may partially absorb liquid output 220. In another embodiment, liquid output 220 may flow through growing medium 403 in droplet form. In another embodiment, liquid output 220 may diffuse through underground growing environment 404 and deeper underground growing environment 440 as a liquid vapor.

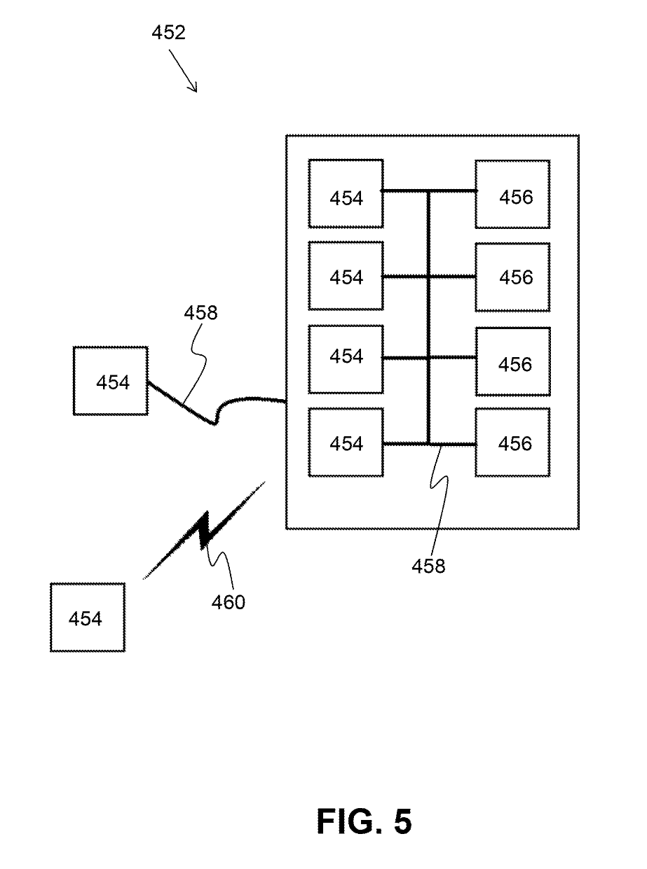

With reference to FIG. 5, a schematic diagram of an example control system 452 is illustrated. While shown as a schematic diagram, various sensors 454 and actuators 456 illustrated on example control system 452 may be either positioned in-situ within an environment, for example, as a sensor probe 454 within deeper underground growing environment 440, operatively connected to control system 452 either by a wired 458, or wireless 460 connection, or as a sensor 454 on control system 452, for example, as a breakout board or shield operatively connected to control system 452 itself. Sensors 454 may be connected to control system 452 via a wired 458 or wireless 460 connection to optimally place a sensor within root development system 400. Placement of control system 452 need not be limited to any location or placement within root development system 400, for example, as shown in FIG. 4, and may be place anywhere most optimal for control purposes, including external to, and remote from root development system 400. Root development system 400 may comprise multiple control systems 452. In one embodiment, root development system 400 comprises a centralized control system 452 to control actuators 456 and monitor sensors 454. In another embodiment, root development system 400 may comprise multiple control systems 452, for example, with each of the multiple control systems 452 assigned to monitor and control a single event/condition. Events/conditions that may be monitored by sensors 454 and controlled by actuators 456 may include, but are not limited to: (1) temperature; (2) humidity; (3) moisture; (4) light levels; (5) total dissolved solids (TDS)/conductivity; (6) pH level; (7) gas concentration; (8) pressure; (9) weight; and (10) presence.

A temperature sensor may be employed to sense a temperature of at least one of: an air temperature of air external to container 446; an air temperature external to container 446 immediately above surface 401 (i.e. ground level), an air temperature of air external to container 446 around plant systems further from surface 401 (i.e. a plant's canopy); a temperature of soil around dome/growing environment interface 438; a temperature of soil in deeper underground growing environment 440, a temperature of soil in contact with an outer surface 208 of dome 206, an air and liquid temperature within internal volume 216, a temperature of liquid within tube 224, a temperature of liquid at liquid source 226, and a temperature of liquid at injector 232. In one embodiment, a temperature sensed by sensor 454 may be automatically recorded as temperature data to provide a grower with valuable temperature data related to growing conditions. In another embodiment, a temperature sensed by sensor 454 may actuate actuator 456 or another device such as heat exchanging element 342 to change a temperature of a condition/element sensed by sensor 454. In one embodiment, actuator 456 may trigger exhaust fan 462 on conduit 344 that may exchange an air from within internal volume 216 in an event where an air within internal volume 216 may not be an optimal temperature for condensation development. In another embodiment, sensor 454 may trigger heat exchanging element 342 to heat a temperature within internal volume 216, and cool a temperature of growing medium 403 in contact with outer surface 208 to encourage liquid output 220 to form as condensation on inner surface 210, may negatively affect surrounding elements of root development system 400. In another embodiment, heat exchanging element 342 may be used to heat/cool a temperature of a liquid, for example liquid within tube 224 to be output as output liquid 220 to an ideal temperature for condensation development on inner surface 210 of dome 206. In another embodiment, actuator 456 may trigger at least one of: an audible alarm, a visual alarm, or an audible/visual alarm to indicate a temperature condition outside a normal temperature range to alert a user of a high/low temperature level.

A relative humidity sensor may be used to sense a relative humidity in a location of at least one of: outside container 446; immediately above surface 401 (i.e. ground level); a relative humidity of air outside the container in various locations such as: outside container 446, immediately above surface 401; external to container 446 around plant systems further from surface 401 (i.e. a plant's canopy); and in internal volume 216. In one embodiment, a humidity sensed by sensor 454 may be automatically recorded as humidity data to provide a grower with valuable humidity data related to growing conditions. In another embodiment, a humidity sensed by sensor 454 may actuate actuator 456 to control another device to regulate and control a humidity of a condition/element sensed by sensor 454. For example, humidity within internal volume 216 of dome 206 may be too high, as sensed by sensor 454. Actuator 456 may trigger exhaust fan 462 to exhaust humid air from within internal volume 216 via conduit 344 to lower a humidity of air within internal volume 216. In another embodiment, a high humidity level as sensed by sensor 454 may prevent solenoid 230 that control liquid flow from liquid source 216 from opening to provide liquid output 220 within internal volume 216 of dome 206. In another embodiment, a relative humidity level sensed by sensor 454 may trigger actuator 456 or heat exchanging element 342 to increase an air temperature within internal volume 216 to increase an amount of vaporized liquid output 220 that may be contained by air within internal volume 216. Control system 454 may control humidity to control an ideal humidity for root development system 400. In one embodiment, control system 452 may sense and control humidity to create and regulate an ideal humidity to prevent a development of fungus within container 446 or internal volume 216 of dome 206. In another embodiment, actuator 456 may trigger at least one of: an audible alarm, a visual alarm, or an audible/visual alarm to indicate a humidity condition outside a normal range to alert a user of a high/low humidity level.

A moisture sensor 454 may be used to sense a moisture m at least one of: growing medium 403 within container 446; within collar 464; within growing medium 403 at dome/growing environment interface 438; within deeper underground growing environment 440; within internal volume 216 of dome 206; and within liquid distribution device 218. In one embodiment, a moisture sensed by sensor 454 may be automatically recorded as moisture data to provide a grower with valuable moisture data related to growing conditions. In another embodiment, a moisture sensed by sensor 454 may actuate actuator 456 to control another device to regulate and control a moisture of a condition/element sensed by sensor 454. In one embodiment, control system 452 may actuate solenoid 230 controlling liquid flow from liquid source 226 to provide a liquid output 220 from liquid distribution device 218 in response to a moisture sensor 454 indicating a less than ideal moisture level. In another embodiment, actuator 456 may trigger fan 462 to exchange an air within internal volume 216 to dry out internal volume 216 and sounding areas, such as dome/growing environment interface 438. In another embodiment, sensor 454 may sense moisture within tube 224 and trigger actuator 456 to cause a pressurized air stream (not shown) to blow out tube 224 to prevent a formation of algae and fungus within tube 224. In another embodiment, actuator 456 may trigger at least one of: an audible alarm, a visual alarm, or an audible/visual alarm to indicate a moisture condition outside a normal range to alert a user of a high/low moisture level.

In one embodiment, a light sensor 454 may be positioned above surface 401 to ensure that above-ground plant systems are receiving enough light. In another embodiment, light sensor 454 may be positioned within internal volume 216 of dome 206 to ensure that root system 100 may not be exposed to high light levels that may negatively affect root development. Light data from light sensor 454 may be automatically recorded as light data to provide a grower with valuable light data related to growing conditions. Actuator 456 may trigger an alarm, for example, an audible alarm such as a noise or buzzer, a visible alarm such as a flashing light or like display, or a combination of both, to alert a grower that a plant 102 may not be positioned to receive an ideal amount of light for root development and plant growth.

A TDS/conductivity sensor 454 may be positioned in at least one of: liquid source 226, tube 224, internal volume 216, and dome/growing environment interface 438. TDS/conductivity sensor 454 may measure inorganic and organic substances dissolved in a liquid source, for example, water, to determine a presence of chemicals within liquid water. In one embodiment, TDS/conductivity sensor 454 may record TDS/conductivity data of different liquid source and automatically record to provide a grower with valuable TDS/conductivity data related to growing conditions. In another embodiment, TDS/conductivity sensor 454 may be positioned inline within tube 224 and used to detect a presence of one or more inorganic fertilizer salts dissolved in water, for example to determine a presence of fertilizer salts within liquid output 220. In another embodiment, TDS/conductivity sensor 454 may be positioned at liquid source 226, for example, a municipal water supply, to determine a presence of chlorine or other chemicals within liquid source 226. In one embodiment, control system 452 may prevent actuation of solenoid 228 to initiate a flow of liquid from liquid source 226 to prevent an atomized mist of liquid output 220 within internal volume 216 if, for example, sensor 454 detects a presence of one or more chemicals within a water from liquid source 226. In another embodiment, actuator 456 may trigger at least one of: an audible alarm, a visual alarm, or an audible/visual alarm to indicate a TDS/conductivity level outside a normal range to alert a user of a high/low TDS/conductivity level.

A pH sensor 454 may be positioned in at least one of: internal volume 216, within growing medium 403, at dome/growing environment interface 240, within tube 224, or at liquid source 226. pH sensor 454 may be used to sense a pH level of a liquid that may be output as liquid output 220. pH sensor 454 may be used to sense a pH level of growing medium 403, for example, a pH level of a soil. In one embodiment, pH sensor 454 may automatically record pH level data to provide a grower with valuable pH data related to growing conditions. In another embodiment, in response to a high/low pH level of a liquid or growing medium 403, actuator 456 may cause a respective acid/basic solution to be added at injector 232 that may respectively lower/raise a pH level of a liquid to be output as liquid output 220, or consequently where liquid output 220 may be absorbed by growing medium 403, growing medium 403. In another embodiment, actuator 456 may trigger at least one of: an audible alarm, a visual alarm, or an audible/visual alarm to indicate a pH level outside a normal range to alert a user of a high/low pH level.

A gas level sensor 454 may be used to detect a gas level or dissolved gas level at a location of at least: immediately above surface 401 (i.e. ground level), further from surface 401 (i.e. around a plant's canopy), internal volume 216, liquid source 226, tube 224, underground growing environment 404, and deeper underground growing environment 440. Gas level sensor 454 may be used to detect a variety of gases that may be necessary in a proper plant growing environment. In one embodiment, gas sensor 454 may automatically record gas concentration level data to provide a grower with valuable gas level concentration data related to growing conditions. In another embodiment, gas level sensor 454 may detect a presence of carbon dioxide (C0₂) needed for plant respiration and photosynthesis around a plant's canopy. In another embodiment, gas level sensor 454 may detect levels of nitrogen and oxygen within deeper underground growing environment 440. In another embodiment, gas level sensor 454 may detect a level of oxygen dissolved in a liquid, for example water, at liquid source 226. In response to a sensed liquid level, actuator 456 may trigger a response. In one embodiment, actuator 456 may trigger an injection of oxygen into a liquid at injector 232 to oxygenate a liquid to be output as liquid output 220. In another embodiment, actuator 456 may trigger at least one of: an audible alarm, a visual alarm, or an audible/visual alarm to indicate a gas level outside a normal range to alert a user of a high/low gas concentration level.

A pressure/weight sensor 454 may be used to detect at least one: an air pressure, and a weight. Pressure/weight sensor 454 may be located in at least one of: underground growing environment 404, embedded in shell 214—that is, between outer surface 208 and inner surface 210, and within internal volume 216. In one embodiment, pressure/weight sensor 454 may automatically record pressure/weight level data to provide a grower with pressure/weight data related to growing conditions. In another embodiment, weight sensor 454 may detect an abnormal amount of force on surface 401 that may exert an abnormal amount of force on dome 206. In another embodiment, weight sensor 454 may detect a weight of root system 100 acting on dome 206 to provide an indication of a plant's growth, and to ensure that root system 100 may be in contact with dome 206. In another embodiment, pressure sensor 454 may sense an air pressure within internal volume 216 of dome 206. In response to an air pressure reading from pressure sensor 454, actuator 456 may trigger, for example, exhaust fan attached to conduit 344 to evacuate a volume of air from within internal volume 216 to normalize an air pressure. In another embodiment, actuator 456 may trigger at least one of: an audible alarm, a visual alarm, or an audible/visual alarm to indicate a weight/air pressure level outside a normal range to alert a user of a high/low weight/air pressure level.

A presence sensor 454 may be located in a location of at least one of: underground growing environment 404, deeper underground growing environment 440, internal volume 216, and tube 214. Presence sensor may be used to detect a presence, for example, of an object or organism. In one embodiment, presence sensor 454 may automatically record an occurrence of presence data to provide a grower with presence data that may affect growing conditions. In another embodiment, presence sensor 454 may sense a presence of growing medium 403, for example, soil, within internal volume 216. In another embodiment, presence sensor 454 may sense a presence of root system 100 within internal volume 216. In another embodiment, presence sensor 454 may detect a presence of an animal inside internal volume 216 of dome 206. In another embodiment, presence sensor 454 may detect a presence of root system 100 in deeper underground growing environment 440. In another embodiment, presence sensor may detect a presence of a liquid within tube 224. In another embodiment, actuator 456 may trigger at least one of: an audible alarm, a visual alarm, or an audible/visual alarm that may indicate a presence of an object/organism if presence of an object/organism may be outside a normal condition.

Control system 452 with sensors 454, actuators 456, and other systems triggered by control system 452 and actuators 456, may better control conditions affecting dome 206 and a growing environment of plant 102. An ideal growing environment in addition to dome 206 may provide an ideal growing environment of root system 100, that may cause ideal growth of above-ground plant systems on plant 102.

Apparatus 200 and system 400 may be limited to performing a specific function. For example dome 206 of apparatus 200 and system 400 may be used primarily to spread, and encourage growth of root system 100 in a particular direction. In this example, liquid distribution device 218 within internal volume 216 may be replace by a liquid distribution device 219 in another location, for example, a drip irrigation system located at surfaces 101/401. Drip irrigation liquid distribution device 219 may saturate growing medium 203/403 near deeper underground growing environment 240/440. Root system 100, in search of resources, may grow toward deeper underground growing environment 240/440 in search resource while dome 206 may affect a direction, and concentration of root growth, such that root system 100 of plant 102 is spread out as plant 102 develops a deep-growth root system 100.

While apparatus 200 and system 400 have been described for use in an underground growing environments 204 and 404 respectively, apparatus 200 and system 400 may not be limited to such environments, for example, as buried in a growing medium 203/403, such as soil. In one embodiment, dome 206 may be adapted for use in a hydroponic system. For example, dome 206 may be adapted to spread a plant's root system 100 in a hydroponic environment to prevent root system 100 from forming a large root ball. An example hydroponic system may not use liquid distribution device 218 and may use dome 206 to influence a direction and distribution of root growth of root system 100.

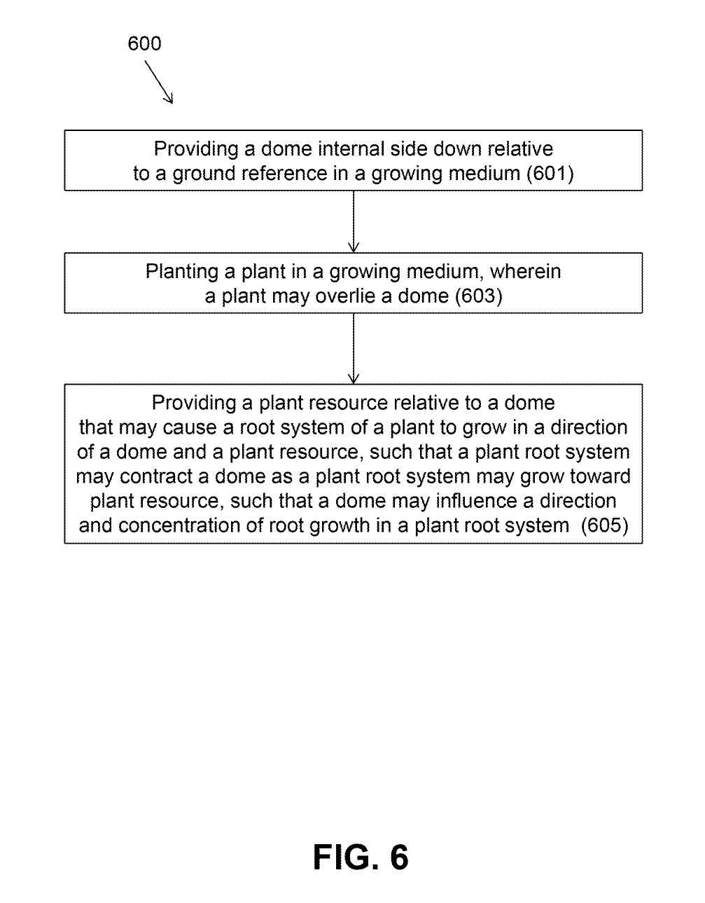

With reference to FIG. 6, a flowchart showing an example method 600 for using a root development apparatus 200 and root development system 400 is provided. Method 600 may comprise: providing a dome internal side down relative to a ground reference in a growing medium (601); planting a plant, wherein a plant may be at least one of: a seed, a sprout, a seedling, and a rooted plant, in a growing medium, wherein a plant may overlie a dome (603); providing a plant resource relative to a dome that may cause a root system of a plant to grow in a direction of a dome and a plant resource, such that a plant root system may contact a dome as a plant root system may grow toward plant resource, such that a dome may influence a direction and concentration of root growth in a plant root system (605).

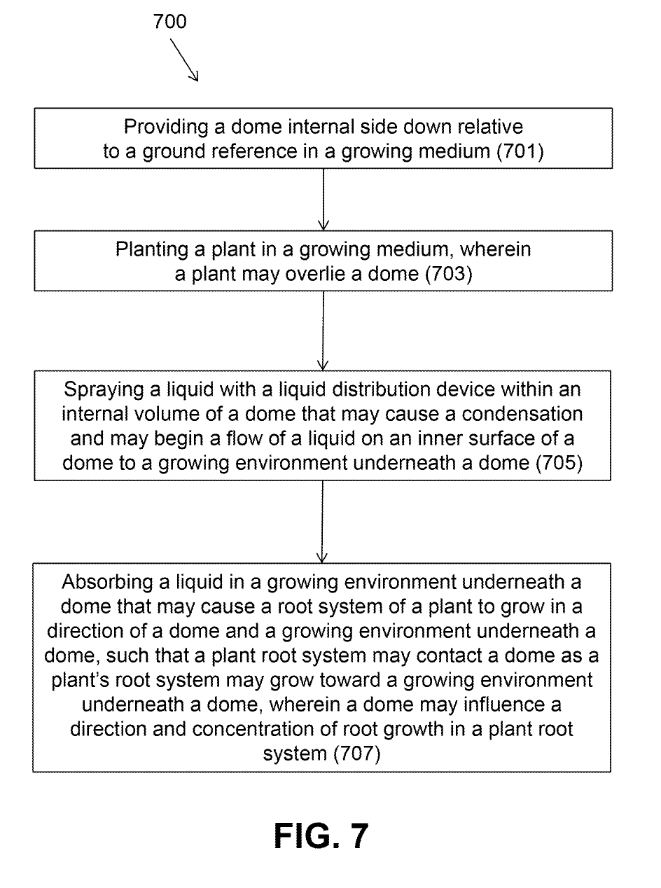

With reference to FIG. 7, a flowchart showing an example method 700 for using a root development apparatus 200 and root development system 400 is provided. Method 700 may comprise: providing a dome internal side down relative to a ground reference in a growing medium (701); planting a plant, wherein a plant may be at least one of: a seed, a sprout, a seedling, and a rooted plant, in a growing medium, wherein a plant may overlie a dome (703); spraying a liquid with a liquid distribution device within an internal volume of a dome that may cause a condensation and may begin a flow of a liquid on an inner surface of a dome to a growing environment underneath a dome (705); absorbing a liquid in a growing environment underneath a dome that may cause a root system of a plant to grow in a direction of a dome and a growing environment underneath the dome, such that a plant root system may contact a dome as a plant's root system may grow toward a growing environment underneath a dome, wherein a dome may influence a direction and concentration of root growth in a root system of a plant (707).

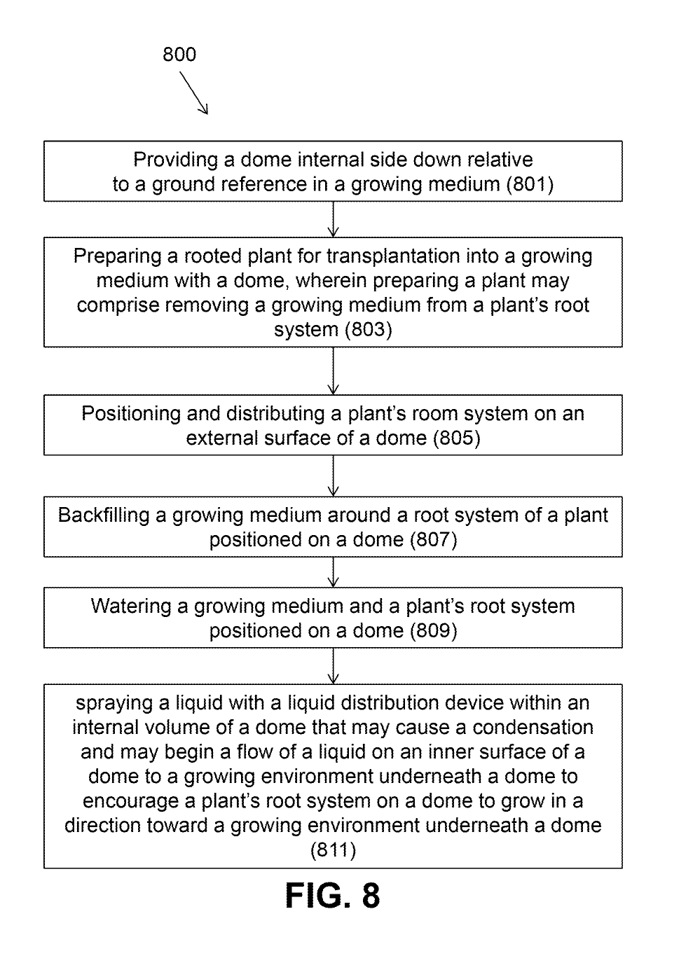

With reference to FIG. 8, a flowchart showing an example method 800 for using a root development apparatus 200 and root development system 400 is provided. Method 800 may comprise: providing a dome internal side down relative to a ground reference in a growing medium (801); preparing a rooted plant for transplantation into a growing medium with a dome, wherein preparing a plant for transplantation may comprise removing a growing medium from a plant's root system (803); positioning and distributing a plant's root system on an external surface of a dome (805); backfilling a growing medium around a root system of a plant positioned on a dome (807); watering a growing medium and a plant's root system of a plant positioned on a dome (809); spraying a liquid with a liquid distribution device within an internal volume of a dome that may cause a condensation and may begin a flow of a liquid on an inner surface of a dome and further to a growing environment underneath a dome to encourage a plant's root system on a dome to grow in a direction toward a growing environment underneath a dome (811).

Temperature data, provided here as an appendix, was taken from an 11 week period from Jul. 25, 2014-Oct. 12, 2014. Temperature data relating to air temperature within dome 206, soil temperature in underground growing environment 204/404, and an above-ground air temperature were recorded at intervals over a time range from 07:00-23:00 (7 am-11 pm). Data suggests that an outside air temperature during afternoon hours 12:00-18:00 (12 pm-6 pm) may be used to heat an air temperature within dome 206, such that an elevated temperature relative to a soil temperature may be maintained from early evening, throughout the night, and into next morning—that is approximately between hours of 18:00-10:00 (6 pm-10 am). A temperature differential between air within an internal volume 216 of dome 206, and underground growing environment 204/404, wherein air temperature within internal volume 216 of dome 206 may be warmer than a soil temperature in underground growing environment 204/404, may be ideal for formation of liquid output 220 as a condensation on inner surface 210 of dome 206. Water was provided around 07:00 (7 am) at a time when air temperature of an internal volume 216 of dome 206 is warmer than surrounding soil temperature of underground growing environment 204/404 so as to cause condensation of liquid output 220 to form on inner surface 210 of dome 206.

Unless specifically stated to the contrary, the numerical parameters set forth in the specification, including the attached claims, are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example embodiments, and while the example embodiments have been described and illustrated in considerable detail, it is not the intention of the applicants to restrict, or in any way limit, the scope of the appended claims to such detail. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and exemplary embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

As used in the specification and the claims, the singular forms “a,” “an,” and “the” include the plural. To the extent that the term “includes” or “including” is employed in the detailed description or the claims, it is intended to be inclusive in a manner co-extensive with the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

What is claimed:

1. An apparatus for developing a root system on a vascular plant and influencing a direction and a concentration of root growth is provided, the apparatus comprising:
a dome operable to support the root system of a plant and encourage the direction and the concentration of root growth on the root system, the dome comprising:
an outer surface,
an inner surface,
and an internal volume,
wherein the outer surface is configured to contact and support the root system to train the direction and the concentration of the root growth on the root system, and wherein the inner surface limits the internal volume of the dome; and
a liquid distribution device, the liquid distribution device operable to distribute a liquid within the internal volume of the dome.

2. The apparatus of claim 1, wherein the dome is comprised of a solid material, the solid material selected from the group chosen from: a polymeric material, a plastic, a metal, a ceramic, a glass, a natural fiber, a synthetic fiber, and a composite.

3. The apparatus of claim 1, wherein the dome is operable for use underground, and wherein the dome is comprised of a solid material to resist a deformation caused by at least one of: a weight of a growing medium; a weight of the plant; a weight of the root system; and an above-ground pressure applied to a ground surface relative to the dome.

4. The apparatus of claim 1, wherein the outer surface of the dome comprises a coating, the coating selected from the group chosen from: a rooting hormone, a mycorrhizae, a beneficial fungi, a beneficial bacterial, a nutrient, a herbicide, a pesticide, and a fertilizer.

5. The apparatus of claim 1, wherein the liquid distribution device further comprises a tubing, the tubing operable to operatively connect the liquid distribution device to a pressurized liquid source.

6. The apparatus of claim 1, wherein the liquid distribution device further comprises a sprayer, the sprayer operable to atomize a liquid into a mist, the sprayer further operable to at least one of: a full rotational spray patterns, and rotate within the internal volume of the dome, to uniformly distribute the mist within the internal volume of the dome.

7. The apparatus of claim 1, further comprising a heat exchanging element, the heat exchanging element operable to exchange a heat of at least one of: contents of the internal volume; the dome, a root tissue in contact with the outer surface of the dome, a growing medium in contact with the outer surface of the dome.

8. The apparatus of claim 1, further comprising a base within the internal volume of the dome, and a connecting member, the connecting member operable to selectively connect to at least one of: the base within the internal volume of the dome, and a rim of the dome, wherein at least one of: the connecting member, and the base, is further operable to limit a subsidence of the apparatus within a growing medium.

9. A system for developing a root system in a plant and influencing a direction and a concentration of root growth, comprising:
a container comprising a first internal volume;
a dome operable to support the root system of the plant and encourage the direction and the concentration of root growth on the root system, the dome comprising:
an outer surface,
an inner surface,
and a second internal volume,
wherein the outer surface is configured to contact and support the root system to train the direction and the concentration of the root growth on the root system, and wherein the inner surface limits the second internal volume of the dome; and
a liquid distribution device, the liquid distribution device operable to distribute a liquid within the first internal volume and the second internal volume.

10. The system of claim 10, wherein the first internal volume of the container is operable to contain at least one of: the plant, a growing medium, the root system of the plant, the liquid distribution device, a tube, a sensor, a heat exchange device, and a drainage device.

11. The system of claim 10, wherein the dome comprises a shape selected from the group chosen from: a cone shape, a cylindrical shape, a pyramid shape, a frustoconical shape, a frustum shape, an incomplete spheroid shape, and a half-spheroid shape

12. The system of claim 10, wherein the liquid distribution device further comprises a tubing, the tubing operable to at least one of: introduce a liquid into, introduce a gas into, remove a liquid from, and remove a gas from, the second internal volume of the dome.

13. The system of claim 10, wherein the liquid distribution device further comprises a sprayer, the sprayer operable to atomize a liquid into a mist, the sprayer further operable to rotate within the second internal volume of the dome to uniformly distribute the mist within the second internal volume of the dome.

14. The system of claim 10, further comprising a heat exchanging element, the heat exchanging element operable to exchange a heat of at least one of: contents of the first internal volume, contents of the second internal volume, the dome, a root tissue in contact with the outer surface of the dome, and a growing medium in contact with the outer surface of the dome.

15. The system of claim 10 further comprising a sensor, the sensor operable to sense at least one of: a moisture, a temperature, a humidity, a light, a pH level of a liquid, a total dissolved solids measure (TDS) of a liquid, a conductivity of a liquid, and an oxygen level

16. The system of claim 10 further comprising a drainage device, the drainage device operable to selectively remove a liquid from all or part of the first internal volume of the container.

17. The system of claim 10 further comprising a collar, wherein the collar envelops a plant stem at an interface between the plant stem and a growing medium to prevent a moisture from contacting the plant stem at the interface.

18. The system of claim 10, further comprising a base within the second internal volume, and a connecting member, the connecting member operable to selectively connect to at least one of: the base within the second internal volume of the dome, and a rim of the dome, wherein at least one of: the connecting member, and the base, is further operable to limit a subsidence of the apparatus within a growing medium.

19. A method for developing a root system in a plant, comprising:
providing a dome internal side down relative to a ground reference in a growing medium, the dome comprising a liquid distribution device within an internal volume;
planting a plant, wherein the plant is at least one of: a seed, a sprout, a seedling, and a rooted plant, in the growing medium, the plant directly overlying the dome;
spraying a liquid with the liquid distribution device within an internal volume of the dome to cause a condensation to form on an inner surface of the dome, wherein the condensation begins a flow of the liquid along the inner surface of the dome toward a growing environment at a location underneath the dome; and
absorbing the liquid in the growing environment underneath the dome to cause a root system of the plant to grow in a direction of the dome and the growing environment underneath the dome, such that the root system of the plant contacts the dome as the root system grows toward the growing environment underneath the dome, wherein the dome influences a direction and concentration of growth in the root system.

20. The method of claim 19, wherein a base within the internal volume of the dome, and a connecting member operable to selectively connect to at least one of: the base within the internal volume of the dome, and a rim of the dome, are operable to limit a subsidence of the dome within the growing medium.
